(19) United States
(12) Patent Application Publication
(10) Pub. No.: US 2024/0246400 A1
(43) Pub. Date: Jul. 25, 2024

(54) RELEASABLE TOP FOR AUTOMOBILE

(71) Applicant: GJR Racing llc, Tobaccoville, NC (US)

(72) Inventor: Eugene Frank Ribas, JR., Tobaccoville, NC (US)

(73) Assignee: GJR Racing llc, Tobaccoville, NC (US)

(21) Appl. No.: 18/100,622

(22) Filed: Jan. 24, 2023

(51) Int. Cl. B60J 7/10; B32B 3/08; B32B 7/08; B32B 27/12

(52) U.S. Cl. CPC B60J 7/104; B32B 3/08; B32B 7/08; B32B 27/12; B32B 2605/00

(57) ABSTRACT

A top for an automobile can include a fabric layer. The top can include a front header cable that is embedded in the fabric layer. The top can include a preformed header rail defining a channel that is configured to releasably couple to a windshield frame of the automobile. The top can include at least one rear strap configured to couple to the automobile and to the fabric layer.

### TECHNICAL FIELD

The present disclosure relates generally to automobile tops and, more particularly (although not necessarily exclusively), to a releasable top for an automobile.

### BACKGROUND

An automobile can include a top that can cover an interior portion of the automobile. It may be useful to provide such tops that are releasable to remove the top from the automobile. But, tops that are releasable may not provide sufficient performance characteristics, such as maintaining a smooth outer surface in response to high automobile speeds.

### SUMMARY

In one example, a top for an automobile can include a fabric layer. The top can include a front header cable that is embedded in the fabric layer. The top can include a preformed header rail defining a channel that is configured to releasably couple to a windshield frame of the automobile. The top can include at least one rear strap configured to couple to the automobile and to the fabric layer.

In another example, an automobile can include a roll bar. The automobile can include a windshield frame. The automobile can also include a top. The top can include a fabric layer, a front header cable that is embedded in the fabric layer, a preformed header rail that defines a channel that is configured to releasably couple to the windshield frame, and at least one rear strap configured to couple to the automobile and to the fabric layer.

In another example, a method can include providing a top for an automobile, the top including a fabric layer, a preformed header rail, a front header cable embedded in the fabric layer, and at least one rear strap. The method can include positioning the preformed header rail with respect to a windshield frame of the automobile. The method can also include positioning the front header cable within a channel defined by the preformed header rail to releasably couple the top to the windshield frame. The method can include coupling the at least one rear strap to the automobile.

### BRIEF DESCRIPTION OF THE DRAWINGS

FIG. 1 is a top view of a releasable top for an automobile according to one example of the present disclosure.

FIG. 2 is an illustration of a releasable top for an automobile that is releasably coupled to an automobile according to one example of the present disclosure.

FIG. 3 is a flowchart of a process for coupling a releasable top to an automobile according to one example of the present disclosure.

### DETAILED DESCRIPTION

Certain aspects and features of the present disclosure relate to a releasable top for an automobile. In some situations, it may be desirable to quickly install a top onto an automobile or remove a top from an automobile. Furthermore, it may also be desirable for the top to be lightweight. The releasable top can include lightweight materials and can be quickly released from or installed on an automobile.

In some examples, the releasable top can include a preformed header rail that can be installed on a windshield frame of the automobile. The preformed header rail can match a shape of the windshield frame of the automobile. In some examples, the preformed header rail can be mechanically engaged to the windshield frame with one or more mechanical fastening devices, such as screws. For example, the windshield frame can include a number of screw holes that can align with matching screw holes on the pre-formed header rail. The preformed header rail can be installed on the windshield frame by screwing in screws. Conversely, the preformed header rail can be removed from the windshield frame by unscrewing screws. The releasable top can include a fabric layer that can cover an interior portion of the automobile when the releasable top has been installed on the automobile. The preformed header rail can include a channel that is sized to receive a front header cable.

The front header cable can be embedded within a portion of the fabric layer such that the front header cable can apply a stretching force to the fabric layer. In some examples, the front header cable can be made from a polymer, such as polyvinyl chloride. Alternatively, the front header cable can be made from any suitable hard material. The front header cable can be positioned within the preformed header rail for releasably coupling the releasable top to the automobile. Similarly, the front header cable can be removed from the preformed header rail for releasing the releasable top from the automobile.

The releasable top can also include one or more rear straps that can couple to the automobile and to the fabric layer. For example, the rear straps can include rings that can wrap around one or more protruding portions of the automobile. For example, the one or more protruding portions of the automobile can include mounting bolts positioned on the rear of the automobile. The rear straps can apply a stretching force to the fabric layer such that the fabric layer is held taut in between the rear straps and the front header cable. In some examples, the releasable top can include a foam stiffener that is positionable between a roll bar of the automobile and the fabric layer for adjusting the shape of the releasable top.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

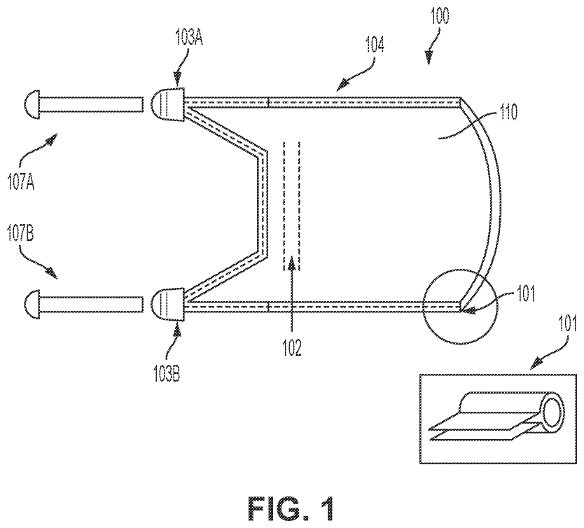

FIG. 1 is a top-down view of a releasable top 100 for an automobile according to one example of the present disclosure. The releasable top 100 can include a fabric layer 110 that can cover an interior portion of the automobile when the releasable top 100 has been installed on the automobile. In some examples, the fabric layer 110 can include an outer layer and an inner layer. The outer layer can be a fabric material, and the inner layer can be a plastic material, a polymer material, a rubber material, or any combination thereof. In some examples, the inner layer can be twill bonded to the inner layer. In some examples, the outer layer can include a waterproof or hydrophobic coating.

In some examples, the fabric layer 110 can include one or more additional layers of material positioned above the fabric layer 110, positioned beneath the fabric layer 110, or both. For example, the fabric layer 110 can include an additional layer of waterproofing or aerodynamic material positioned above the fabric layer 110 with respect to the automobile. Additionally or alternatively, the fabric layer 110 can include a layer of interior fabric positioned beneath the fabric layer 110 and facing an interior portion of the automobile. The one or more additional layers of fabric can be glued onto the fabric layer 110, stapled to the fabric layer 110, sewn onto the fabric layer 110, taped onto the fabric layer 110, or otherwise affixed to the fabric layer 110 using any other suitable technique.

In some examples, the fabric layer 110 can include mounting brackets positioned thereon for releasably attaching the one or more additional layers of material in a modular fashion. For example, a user of the automobile can use the mounting brackets quickly attach the one or more additional layers of material to the fabric layer 110 by positioning the one or more additional layers of material within the mounting brackets. The mounting brackets may include one or more fastening devices that can be used for fastening the one or more additional layers of material to the fabric layer 110 and for releasing the one or more additional layers of material from the fabric layer 110.

In some examples, it may be desirable to apply the releasable top 100 to an automobile with a roll cage. The fabric layer 110 can be sized to receive and stretch over a roll cage of the automobile. In some examples, the fabric layer 110 can include one or more interior straps that are positioned to receive one or more portions of the roll cage. For example, the one or more interior straps can be wrapped around one or more portions of the roll cage to further secure the fabric layer 110 to the roll cage.

The fabric layer 110 can include a front header cable 101 that can be used for releasably coupling the releasable top 100 to a windshield frame. The front header cable 101 can be embedded within a portion of the fabric layer 110 such that the front header cable 101 can apply a stretching force to the fabric layer 110. In some examples, the front header cable 101 can be made from a polymer, such as polyvinyl chloride (PVC). For example, the front header cable 101 can be a 19/64 reinforced PVC cable. The front header cable 101 can be sewn to the fabric layer 110. For example, the front header cable 101 can be sewn to the fabric layer 110 using triple-wound and bonded polyester. Alternatively, the front header cable 101 can be made from any suitable material or combination of materials, such as a metal alloy.

Additionally or alternatively, the front header cable 101 can be releasable with respect to the fabric layer 110. For example, the fabric layer 110 can include a hollow portion for receiving the front header cable 101 and one or more locking mechanisms for keeping the front header cable 101 locked in place with respect to the fabric layer 110. In some examples, the fabric layer 110 can include multiple front header cables 101 that can be positioned in different locations within the fabric layer 110.

The front header cable 101 can be positioned within a preformed header rail for releasably coupling the releasable top 100 to the automobile. Similarly, the front header cable 101 can be removed from the preformed header rail for releasing the releasable top 100 from the automobile. The front header cable 101 can include a round cross-section for conforming to the shape a channel defined by the preformed header rail. In some examples, the front header cable 101 can frictionally engage with an exposed surface of the channel portion of the preformed header rail such that the front header cable 101 forms an interference fit with the channel portion of the preformed header rail.

In some examples, the releasable top 100 can include a paracord 104 or other suitable cord that can be embedded within the fabric layer 110 of the releasable top 100. The paracord 104 can be sewn into the sides of the fabric layer 110. Additionally or alternatively, the paracord 104 can be positioned within a hollow portion of the fabric layer 110 that can be sized to receive the paracord 104. The paracord 104 can be used to adjust the shape of the releasable top 100. For example, a user of the automobile can pull on an exposed portion of the paracord 104 to adjust the shape of the fabric layer 110. Once adjusted, the paracord 104 can mitigate flapping and billowing responses of the fabric layer 110 that may be caused by wind, and can improve the aerodynamics of the automobile to which the releasable top 100 is attached. In some examples, the releasable top 100 can be designed to withstand speeds of 150 miles per hour or more.

The releasable top 100 can include one or more rear straps 107a-b that can couple to the automobile and to the fabric layer 110. For example, the rear straps 107a-b can be coupled to rings that can wrap around one or more protruding portions of the automobile. For example, the rings can be metal D-rings that are sized to receive the protruding portions of the automobile. The rear straps 107a-b can apply a stretching force to the fabric layer such that the fabric layer is held taut between the rear straps and the front header cable 101. In some examples, the releasable top 100 can include a stiffener 102 that is sized to engage with a roll bar of the automobile.

The stiffener 102 can be positioned between the roll bar of the automobile and the fabric layer 110 of the releasable top 100 for adjusting the shape of the releasable top 100. In some examples, the stiffener 102 can be a foam stiffener. In some examples, the stiffener 102 can be an adjustable stiffener 102 with a spring-based mechanism for adjusting the height of a portion of the fabric layer 110 of the releasable top 100. The stiffener 102 can increase an amount of headroom for passengers of the automobile by adjusting a height of the fabric layer 110 relative to the interior portion of the automobile. In some examples, the rear straps 107a-b can be adjusted by their respective slide buckles 103a-b. Adjusting the rear straps 107a-b via the slide buckles 103a-b can adjust a shape of the releasable top 100.

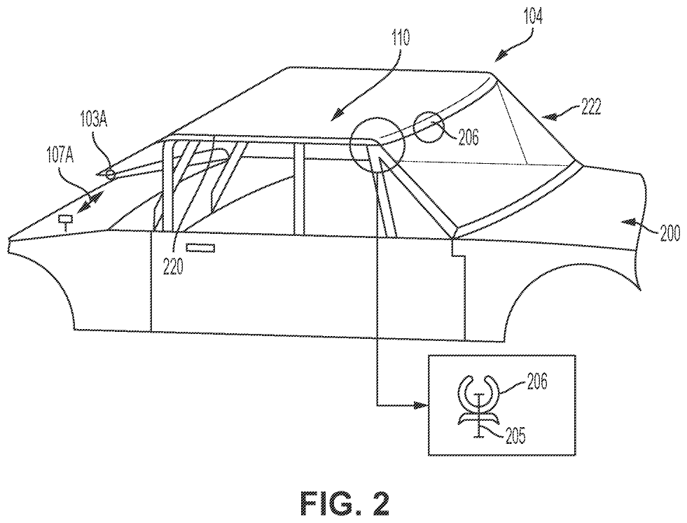

FIG. 2 is an illustration of a releasable top 100 for an automobile 200 that is releasably coupled to an automobile 200 according to one example of the present disclosure. In some examples, the releasable top 100 can include a preformed header rail 206 that can be installed on a windshield frame 222 of the automobile 200. The preformed header rail 206 can be pre-bent prior to installation to match a shape of the windshield frame of the automobile 200. In some examples, the preformed header rail 206 can be mechanically engaged to the windshield frame 222 with one or more fasteners 205, such as screws. For example, the windshield frame 222 can include a number of screw holes that can align with matching screw holes on the pre-formed header rail. The preformed header rail 206 can be installed on the windshield frame by screwing in the screws.

Conversely, the preformed header rail 206 can be removed from the windshield frame 222 by unscrewing the screws. In some examples, the preformed header rail 206 can be mechanically engaged to the windshield frame 222 by tape or a similar adhesive substance. Additionally or alternatively, the preformed header rail 206 can be mechanically engaged to the windshield frame 222 with a hook and loop fastener. In some examples, the preformed header rail 206 can include a magnetic device that is configured to magnetically couple the preformed header rail 206 to the windshield frame 222. Additionally or alternatively, the windshield frame 222 can include a magnetic device that can magnetically couple the preformed header rail 206 to the windshield frame 222.

The releasable top 100 can include a fabric layer 110 that can cover an interior portion of the automobile 200 when the releasable top 100 has been installed on the automobile 200. The preformed header rail 206 can define a channel that is sized to receive the front header cable 101 depicted in FIG. 1. The channel can have a curved shape for receiving the front header cable 101. For example, the channel can be a C-channel, a U-channel, or any other suitable channel that is sized to receive the front header cable 206. The preformed header rail 206 can be made from plastic or any other suitable material. In some examples, the releasable top 100 can include multiple preformed header rails 206 that can be positioned at various points along the windshield frame and can jointly receive the front header cable 101.

In some examples, the fabric layer 110 can include multiple front header cables 101, each front header cable 101 being positioned within an insert in the fabric layer 110. In some examples, the preformed header rail 206 can include multiple channels that can be sized to receive the front header cables 101. In some examples, the preformed header rails 206 can frictionally engage with the front header cables 101. For example, a first front header cable 101 can be inserted into a first preformed header rail 206 to frictionally engage with the first preformed header rail 206, and the second front header cable 101 can be inserted into a second preformed header rail 206 to frictionally engage with the second preformed header rail 206.

In some examples, the releasable top 100 can include multiple preformed header rails 206. For example, the releasable top can include a first preformed header rail 206 mounted on a left portion of the windshield frame 222, and a second preformed header rail 206 that can be mounted on a right portion of the windshield frame. Additionally or alternatively, the first preformed header rail 206 can be mounted on a front portion of the windshield frame 222, and the second preformed header rail 206 can be mounted on a rear portion of the windshield frame 222. In this example, releasably coupling the releasable top 100 to the automobile 200 can involve inserting the front header cable 101 into the first preformed header rail 206 and inserting the front header cable 101 into the second preformed header rail 206.

In some examples, the releasable top 100 can include multiple preformed header rails 206 and multiple front header cables 101. In a specific, illustrative example, the releasable top can include two preformed header rails 206 that are sized to receive two preformed header cables 101. In such an example, releasably coupling the releasable top 100 to the automobile 200 can involve inserting the first front header cable 101 into the first preformed header rail 206, and inserting the second front header cable 101 into the second preformed header rail 206. Alternatively, releasably coupling the releasable top to the automobile can involve inserting the first front header cable into the second preformed header rail 206 and inserting the second front header cable into the first preformed header rail 206.

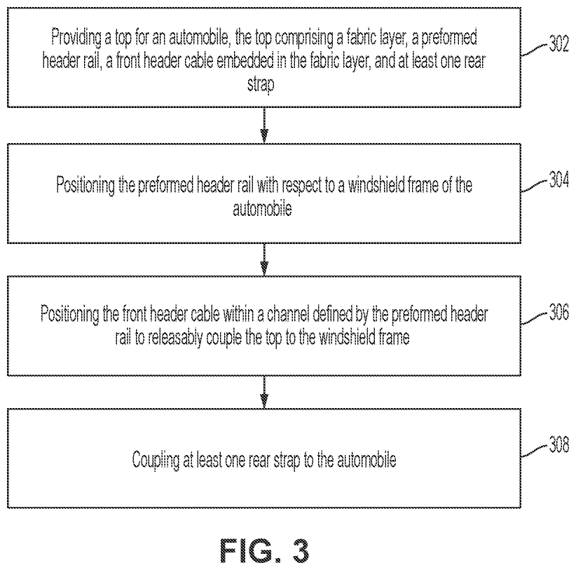

FIG. 3 is a flowchart of a process for coupling a releasable top 100 to an automobile 200 according to one example of the present disclosure. Steps of the process outlined in FIG. 3 are described with reference to components described in FIG. 1 and FIG. 2 of the present disclosure.

Block 302 involves providing a top 100 for an automobile 200. The top 100 can include a fabric layer 110, a preformed header rail 206, a front header cable 101 embedded in the fabric layer 110, and at least one rear strap. In some examples, the at least one rear strap can include a first rear strap 107a and a second rear strap 107a. The rear straps 107a-b can each include a slide buckle 103a-b that enables a user of the automobile 200 to adjust the relative position of the rear straps 107a-b. In some examples, the rear straps 107a-b can be coupled to the fabric layer 110 by a webbing of additional straps. The additional straps can be positioned to alter a shape of the top 100 and can adjust a relative position of the fabric layer 110 with respect to the automobile 200.

For example, the rear straps 107a-b can each be coupled to the fabric layer 110 by a V-shaped webbing of two or more straps each. The V-shaped webbings can distribute stretching forces evenly across the fabric layer 110. Alternatively, the rear straps 107a-b can be coupled directly to the fabric layer 110 or via a single strap that can couple to a corner of the fabric layer 110. In some examples, the V-shaped webbings can be flexible and can enable the fabric layer 110 to move while also keeping the fabric layer 110 in place and taut.

Block 304 involves positioning the preformed header rail 206 with respect to a windshield frame 222 of the automobile 200. Positioning the preformed header rail 206 with respect to the windshield frame 222 can involve drilling holes in the windshield frame 222 that are sized to receive screws or other fasteners. In some examples, positioning the preformed header rail 206 with respect to the windshield frame 222 can involve positioning one or more pieces of tape or other adhesive on the windshield frame 222 and the preformed header rail 206. In some examples, the preformed header rail 206 can be mechanically fastened to the windshield frame 222 by screwing in one or more screws. For example, the preformed header rail 206 can be mechanically fastened to the windshield frame with 9 no. 6¾ inch screws.

In some examples, positioning the preformed header rail 206 with respect to the windshield frame 222 can involve applying an adhesive substance to the bottom of the preformed header rail 206 such that the adhesive substance can make contact with the windshield frame 222. In some examples, positioning the preformed header rail 206 with respect to the windshield frame 222 can involve applying one or more pieces of bonding tape to the preformed header rail 206 and the windshield frame 222.

Block 306 involves positioning the front header cable 101 within a channel defined by the preformed header rail 206 to releasably couple the top 100 to the windshield frame 222. The front header cable 101 can be made from reinforced polyvinyl chloride (PVC). In some examples, the front header cable 101 can include aluminum, copper, iron, stainless steel, or any other suitable material. In some examples, the front header cable 101 can include several cables that have been twisted together. In some examples, the front header cable 101 can mechanically couple to the preformed header rail 206 via the channel. In some examples, the front header cable 101 can be constructed from metal or an alloy containing multiple metals.

Positioning the front header cable 101 within the channel defined by the preformed header rail 206 can involve frictionally engaging a portion of the fabric layer 110 with both the front header cable 101 and the channel defined by the preformed header rail 206 such that the fabric layer 110 forms an interference fit with the channel defined by the preformed header rail 206. In some examples, the fabric layer 110 can include an insert that is sized to receive the front header cable 101. Additionally, the fabric later can include multiple inserts, each of which is sized to receive a front header cable 101.

In some examples, the fabric layer 110 can include multiple front header cables 101, each front header cable 101 being positioned within an insert in the fabric layer 110. In some examples, the preformed header rail 206 can include multiple channels that can be sized to receive the front header cables 101. In some examples, the preformed header rails 206 can frictionally engage with the front header cables 101. For example, a first front header cable 101 can be inserted into a first preformed header rail 206 to frictionally engage with the first preformed header rail 206, and the second front header cable 101 can be inserted into a second preformed header rail 206 to frictionally engage with the second preformed header rail 206.

In some examples, the releasable top 100 can include multiple preformed header rails 206. For example, the releasable top can include a first preformed header rail 206 mounted on a left portion of the windshield frame 222, and a second preformed header rail 206 that can be mounted on a right portion of the windshield frame. Additionally or alternatively, the first preformed header rail 206 can be mounted on a front portion of the windshield frame 222, and the second preformed header rail 206 can be mounted on a rear portion of the windshield frame 222. In this example, releasably coupling the releasable top 100 to the automobile 200 can involve inserting the front header cable 101 into the first preformed header rail 206 and inserting the front header cable 101 into the second preformed header rail 206.

In some examples, the releasable top 100 can include multiple preformed header rails 206 and multiple front header cables 101. In a specific, illustrative example, the releasable top can include two preformed header rails 206 that are sized to receive two preformed header cables 101. In such an example, releasably coupling the releasable top 100 to the automobile 200 can involve inserting the first front header cable 101 into the first preformed header rail 206, and inserting the second front header cable 101 into the second preformed header rail 206. Alternatively, releasably coupling the releasable top to the automobile can involve inserting the first front header cable into the second preformed header rail 206 and inserting the second front header cable into the first preformed header rail 206.

Block 308 involves coupling the at least one rear strap 107a-b to the automobile 200. In some examples, the automobile 200 can include one or more protruding portions for receiving the at least one rear strap 107a-b. For example, the protruding portions can include hooks, mounting brackets, or other similar mounting apparatuses that can be used to releasably couple the top 100 to the automobile 200. For example, the rear straps 107a-b can be coupled to rings that can wrap around one or more protruding portions of the automobile 200. In some examples, coupling the at least one rear strap 107a-b to the automobile 200 can involve applying an adhesive substance to a portion of each of the at least one rear strap 107a-b. Once the adhesive substance has been applied to each rear strap 107a-b, coupling the at least one rear strap 107a-b to the automobile 200 can involve positioning the adhesive portions of each rear strap 107a-b with respect to the automobile 200 such that the rear straps 107a-b are adhesively coupled to an exterior of the automobile 200.

For example, the rings can be welded metal D-rings, cargo rings, O-rings, or any other suitable pieces of hardware that are sized to receive the protruding portions of the automobile 200. In some examples, the rings can be carabiner-style clips that can be opened to receive the protruding portion of the automobile 200. The rear straps 107a-b can apply a stretching force to the fabric layer such that the fabric layer is held taut between the rear straps 107a-b and the front header cable 101.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A top for an automobile, the top comprising:
a fabric layer;
a front header cable that is embedded in the fabric layer;
a preformed header rail defining a channel that is configured to releasably couple to a windshield frame of the automobile; and
at least one rear strap configured to couple to the automobile and to the fabric layer.

2. The top of claim 1, wherein the fabric layer comprises an outer layer and an inner layer, wherein the inner layer is plastic and the outer layer is configured to be twill bonded to the inner layer.

3. The top of claim 1, wherein the at least one rear strap comprises a first rear strap and a second rear strap, wherein each of the first rear strap and the second rear strap includes a slide buckle for coupling to the automobile.

4. The top of claim 1, further comprising a paracord embedded in the fabric layer, wherein the front header cable is configured to mechanically couple to the preformed header rail via the channel.

5. The top of claim 1, further comprising a foam stiffener that is sized to engage with a roll bar of the automobile.

6. The top of claim 1, wherein the preformed header rail is pre-bent to correspond in shape to the windshield frame, wherein the channel has a curved shape for receiving the front header cable.

7. The top of claim 6, wherein the front header cable is a reinforced polyvinyl chloride (PVC) cable.

8. An automobile comprising:
a roll bar;
a windshield frame; and
a top comprising:
a fabric layer;
a front header cable that is embedded in the fabric layer;
a preformed header rail defining a channel that is configured to releasably couple to the windshield frame; and
at least one rear strap configured to couple to the automobile and to the fabric layer.

9. The automobile of claim 8, wherein the fabric layer comprises an outer layer and an inner layer, wherein the inner layer is plastic and the outer layer is configured to be twill bonded to the inner layer.

10. The automobile of claim 8, wherein the at least one rear strap comprises a first rear strap and a second rear strap, wherein each of the first rear strap and the second rear strap includes a slide buckle for coupling to the automobile.

11. The automobile of claim 8, further comprising a paracord embedded in the fabric layer, wherein the front header cable is configured to mechanically couple to the preformed header rail via the channel.

12. The automobile of claim 8, further comprising a foam stiffener that is sized to engage with the roll bar of the automobile.

13. The automobile of claim 8, wherein the preformed header rail is pre-bent to correspond in shape to the windshield frame, wherein the channel has a curved shape for receiving the front header cable.

14. The automobile of claim 13, wherein the front header cable is a reinforced polyvinyl chloride (PVC) cable.

15. A method comprising:
providing a top for an automobile, the top comprising a fabric layer, a preformed header rail, a front header cable embedded in the fabric layer, and at least one rear strap;
positioning the preformed header rail with respect to a windshield frame of the automobile;
positioning the front header cable within a channel defined by the preformed header rail to releasably couple the top to the windshield frame; and
coupling the at least one rear strap to the automobile.

16. The method of claim 15, wherein the fabric layer comprises an outer layer and an inner layer, wherein the inner layer is formed from plastic and the outer layer is twill bonded to the inner layer.

17. The method of claim 15, wherein the at least one rear strap comprises a first rear strap and a second rear strap, wherein each of the first rear strap and the second rear strap includes a slide buckle that couples to the automobile.

18. The method of claim 15, further comprising embedding a paracord in the fabric layer, wherein the front header cable is mechanically coupled to the preformed header rail via the channel.

19. The method of claim 15, further comprising a foam stiffener that is sized to engage with a roll bar of the automobile.

20. The method of claim 15, wherein the preformed header rail is pre-bent to correspond in shape to the top of the windshield frame, wherein the channel has a curved shape for receiving the front header cable, and wherein the front header cable is a reinforced polyvinyl chloride (PVC) cable.
